(19) United States
(12) Patent Application Publication
(10) Pub. No.: US 2006/0287874 A1
(43) Pub. Date: Dec. 21, 2006

(54) Management of information pertaining to application sales opportunities

(76) Inventors: Eric L. Askeland, Lakeville, MN (US); Michele H. Pollock, Inver Grove Heights, MN (US); Scott T. Buss, St. Paul, MN (US)

Correspondence Address: 3M INNOVATIVE PROPERTIES COMPANY, PO BOX 33427, ST. PAUL, MN, 55133-3427, US

(21) Appl. No.: 11/155,823

(22) Filed: Jun. 17, 2005

(51) Int. Cl. G06Q 99/00; G07G 1/14; G06Q 30/00

(52) U.S. Cl. 705/1; 705/14

(57) ABSTRACT

Described are a computer-implemented system and methods for the aggregation, organization and management of material related to the selection and pursuit of targeted applications for the sale of products. A system receives application inputs of three types: account selection aspects, video production aspects and application profile aspects. A user interface receives application inputs related to a particular sales opportunity and links related application inputs to one another. A rules engine authorizes generation of the outputs for evaluation and pursuit of a given sales opportunity when the user interface has received an account selection aspect, a video production aspect and an application profile aspect for that sales opportunities. The methods are directed to management of the account selection aspects, video production aspects and application profile aspects.

### TECHNICAL FIELD

The invention relates to management of sales information and activities and, in particular, computer-implemented systems for managing targeted sales applications.

### BACKGROUND

For a large product-producing company, bringing a product to a customer is typically a team effort, with different operations being principally managed by different departments. For example, an engineering department can design and test the product, a marketing department can promote the product to a broad potential customer base, a sales department can sell the product to individual customers, and a technical services department can provide instruction and other technical support.

In some cases, the company desires to create new sales opportunities for one or more of its products, by proactively investigating a customer or a class of customers that could benefit from use of the products. In other words, the company desires to identify new, targeted applications for its products and the potential customers that may most benefit from the new applications.

Targeting the sales opportunity often includes preparation of informational materials that may be useful in selling the product, instructing the prospective customer how to use the product, or demonstrating the use of the product in the context that the prospective customer would use it. Such visually oriented information is sometimes presented in a video on a recording medium such as a DVD.

In some cases, a company may assemble information that may be useful in assessing identified targeted product applications. Traditionally, companies have employed an ad hoc process of assessing potential targeted product applications, and assembling video production information and or other material related to the selection and pursuit of the targeted sales opportunity. The ad hoc process often involves multiple departments performing isolated functions. For example, the marketing department might assemble information to aid selection of accounts, a video production department could be responsible for assembling video production information, and the sales, technical services and engineering departments may contribute additional information related to the targeted application.

The ad hoc process is susceptible, for example, to incomplete or inconsistent material related to the selection and pursuit of targeted applications.

### SUMMARY

In general, the invention is directed to techniques for the aggregation, organization and management of material related to the selection and pursuit of targeted applications. For example, the techniques provide for the aggregation and logical association of account selection criteria, video production information and data for an application profile for each identified targeted sales opportunity.

In general, an account selection criteria matrix is an organized collection of data that can be used to prepare an account selection report to aid determination of whether an application is appropriate for a given potential customer. A video checklist includes directions for preparation of a video about the product, which drives the content of video material produced for a given targeted sales application. An application profile provides a range of information about the product's application in the targeted market, and pertains to information that describes a targeted sales opportunity.

Typically, an account selection criteria matrix, a video production checklist and an application profile for a given targeted opportunity are likely to include considerable overlap in data, or are likely to include related information pertaining to aspects of the selected products. Consequently, the invention provides for a system that receives “application inputs” pertaining to account selection criteria, video production information or an application profile, or any combination thereof. Application inputs include an “account selection aspect,” which pertains to account selection criteria, a “video production aspect,” which pertains to video preparation, and an “application profile” aspect, which pertains to information about a targeted sales opportunity.

The application inputs are “linked” to one another for each identified targeted application. Hence, an application input is viewed in relation to other application inputs pertaining to the same targeted sales application. As a result, the described techniques may make the process of identifying and pursuing targeted sales opportunities more concerted and less ad hoc.

When a user, such as a company employee, enters an application input such as an account selection aspect into a computer system, the system links the newly provided information to a video production aspect and an application profile aspect. Similarly, when the user enters a video production aspect, the system links the information to an account selection aspect and an application profile aspect. When the user enters an application profile aspect, the system links the information to an account selection aspect and a video production aspect.

For example, the marketing department may assemble information about introducing a product for a particular use in a target market. That information may bear, for example, upon how the product is to be used and how it is superior to other products currently being used. The marketing department may deem this information is useful to the account selection criteria, but the information can also be useful to the application profile and the video production. The application profile may provide technical specifications concerning use of the product in that market, and the video production may desire to show how the product can be used in that use. In some instances, the system may require input of information related to all aspects (i.e., video production, account selection and application profile) before the targeted application may be reviewed, selected and ultimately pursued. In this manner, the system may require and collect complete, consistent information for identified applications. Moreover, the system may automatically generate checklists or other material for use during the process, thereby enforcing a consistent, standardized approach for each newly identified target application.

In one embodiment, the invention is directed to a computer-implemented system comprising a user interface and a rules engine. The user interface is configured to receive an account selection aspect, a video production aspect and an application profile aspect for a sales opportunity for an application of a product. The rules engine is configured to permit output of an account selection criteria matrix, a video checklist, an application profile and approval of the sales opportunity when the user interface has received the account selection aspect, the video production aspect and the application profile aspect.

In another embodiment, the invention is directed to a method comprising receiving an account selection aspect, a video production aspect and an application profile aspect that describe a sales opportunity for an application of a product or service of an enterprise. The method also includes generating with a computer an account selection criteria matrix, a video checklist and an application profile after receiving the account selection aspect, the video production aspect and the application profile aspect.

In a further embodiment, the invention is directed to a method comprising receiving in a first input area of a software application operating on a computer a first application input for a sales opportunity. The first application input comprises one application input type: an account selection aspect, a video production aspect or an application profile aspect. The first input area is linked to a second input area for a second application input of a type different from the first application input, and the first input area is also linked to a third input area for a third application input of a type different from the first application input. The method further includes controlling output of material for evaluation of the sales opportunity based on whether application inputs are provided for the linked first, second and third input areas.

In additional embodiments, the invention is directed to computer-readable medium comprising instructions for causing a programmable processor to carry out any of the methods of the invention.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary information management system that manages account selection aspects, video production aspects and application profile aspects for targeted sales applications for a company.

FIG. 2 is a flowchart illustrating generation of outputs produced by the information management system of FIG. 1, as well as refinement of those outputs.

FIG. 3 is a conceptual diagram showing logical linkages (i.e., required relationships) among application inputs pertaining to subject matter utilized by the information management system for each targeted sales application.

FIG. 4 is an illustration of an exemplary user interface of the information management system to receive application inputs specifying a new targeted sales application.

FIG. 5 is an exemplary account selection criteria matrix generated by the information management system to aid determination of whether an application is appropriate for a given potential customer.

FIG. 6 is an exemplary video checklist generated by the information management system that drives the content of video material produced for a given targeted sales application.

FIG. 7 is an exemplary application profile generated by the information management system that describes the target market, the application and product(s) from the company to be used for the specific application.

### DETAILED DESCRIPTION

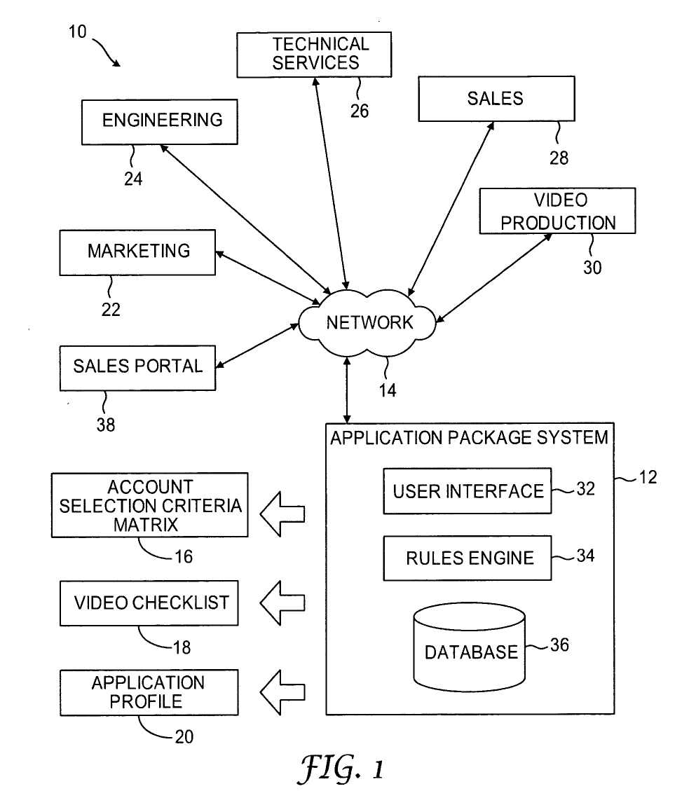

FIG. 1 is a block diagram illustrating an information management system 10. System 10 manages application inputs submitted to an application package system 12 by authorized users associated with one or more company departments for identified target sales opportunities. Application inputs for target sales opportunities include account selection aspects, video production aspects and application profile aspects. Application package system 12 receives the application inputs via network 14, which can comprise any communication network such as a local area network or the Internet.

Application package system 12 is configured to maintain and present at least three outputs based upon the inputs: an account selection criteria matrix 16, a video checklist 18 and an application profile 20.

In a process referred to herein as “account selection,” one or more company representatives investigate the new opportunity, determine what customer needs are not being met, and collect facts to help determine whether the company's product would help meet those needs and how the company's product would help meet those needs. The representatives interact with application package system 12 to provide the account selection information, referred to herein as “account selection criteria.” Application package system 12 may maintain the account selection criteria in an account selection criteria matrix 16, which is an organized collection of data that can be used to prepare an account selection report to aid determination of whether an application is appropriate for a given potential customer. In some embodiments, the account selection matrix can be the final account selection report, but typically the information in the account selection matrix is a preliminary collection of data that can be edited into a final account selection report.

Video checklist 18 includes directions for preparation of a video about the product. Application package system generates video checklist 18 to drive the content of video material produced for a given targeted sales application so that the video material is consistent with account selection criteria matrix 16 and application profile 20 for the particular application.

Application profile 20 is a documentary output that provides a range of information about the product's application in the targeted market. The term “application profile” is used herein to describe information generated by application package system 12 that describes the targeted sales opportunity. For example, application profile may describe the target market, the products' application in the market, advantages and benefits of the products, technical specifications for the products, tools associated with the products, operating parameters for the products, accessories for the products, pictures of the products, an identification of products that could be replaced by the company's products, technical tips for using the product, or other information relevant to the targeted application.

Application package system 12 may receive application inputs from any of a number of departments, such as a marketing department 22, an engineering department 24, a technical services department 26, a sales department 28 and a video production department 30. In the example of FIG. 1, application package system 12 includes a user interface 32, a rules engine 34 and a database 36. Communications among the elements of information management system 10 may take the form of encrypted, secure communications. For example, the communications may be encrypted using the Secure Sockets Layer (SSL), Secure HTTP (S-HTTP) or IP Security (IPSec) network protocols.

User interface 32 provides an interface by which any authorized user can remotely view or submit application inputs to application package system 12. For example, a user within marketing department 22 may submit an account selection aspect pertaining to a kind of business that can employ a particular product. This account selection aspect is automatically linked to a video production aspect and to an application profile aspect for the particular application sales opportunity, which may be entered at an earlier time, at the same time, or at a later time.

The linked account selection aspect, video production aspect and application profile aspect are generally directed to the same or similar subject matter (i.e., a particular application sales opportunity). For example, a technical tip for using the product in a particular application can be useful for account selection criteria matrix 16, video checklist 18 and application profile 20. Accordingly, by interacting with application package system 12, the technical tip can be associated (i.e., “linked”) with an account selection aspect, a video production aspect and an application profile aspect for a particular application sales opportunity.

User interface 32 enables a user to view account selection aspects, video production aspects and application profile aspects that are linked to a common application sales opportunity. User interface 32 further enables a user to add application inputs that are linked to previously entered application inputs. User interface 32 may present to a user an input area for capturing information using any input entry technique. User interface 32 may present to a user, for example, a dialog box, a drop-down menu, a data entry field, and the like.

One form of user interface 32 is a spreadsheet, i.e., a dynamic interface that organizes data in cells arranged in rows and columns. Relationships may be defined in a spreadsheet to link one cell to one or more cells such that data entry in one cell affects a linked cell. An example of a spreadsheet program is that marketed under the trade designation “EXCEL™” by Microsoft Corporation, Redmond, Wash.

In one embodiment, user interface 32 presents a spreadsheet type interface by which users provides the application inputs for targeted sales applications. Rules engine 34 applies rules to govern the receipt and processing of the application inputs. For example, a user may interact with a spreadsheet-like window provided by user interface 32 to enter an application input of one type into one or more cells. When a user enters, for example, an account selection aspect in a first set of cells, application package system 10 or a client computer presenting the spreadsheet automatically links that first set of cells to a second set of cells that provide an input area for a video production aspect and a third set of cells that provide an input area for an application profile aspect pertaining to the same targeted sales application.

Rules engine 34 provides a high-level, automated control over the identification, definition, selection and pursuit of targeted sales applications. For example, rules engine 34 may assure that outputs 16, 18 and 20 are not generated for a particular sales application opportunity unless all of the linked application inputs have been received for that sales application opportunity. In other words, before an opportunity may be formally selected for pursuit, rules engine 34 determines whether the corresponding account selection aspect, a video production aspect and an application profile aspect have all been provided and correctly linked for that opportunity. Thus, when a user wishes to generate one or more outputs 16, 18 and 20 for a particular sales opportunity, rules engine 34 determines whether each linked account selection aspect, video production aspect and application profile aspect have all been provided. If any of the application inputs is missing, rules engine 34 may generate a warning that data entry is incomplete, and may prompt a user to supply missing data via user interface 32.

In this way, rules engine 34 promotes cooperation and consistency among the various departments in the company, and requires a standard approach to defining and assessing potential application opportunities. As a result, the departments can work more closely as a team and each department can have access to the ideas of other departments. This management of application inputs can lead to outputs 16, 18 and 20 that are in harmony with one another, that complement one another, and that are consistent with one another.

Database 36 stores the linked application inputs provided by the departments. Database can also store the data that make up outputs 16, 18 and 20. Further, database 36 can store final versions of account selection criteria based upon account selection criteria matrix 16, a final video based upon video checklist 18, and a final application profile based upon application profile 20. In some embodiments, these final versions of the outputs can be available electronically through a sales portal 38.

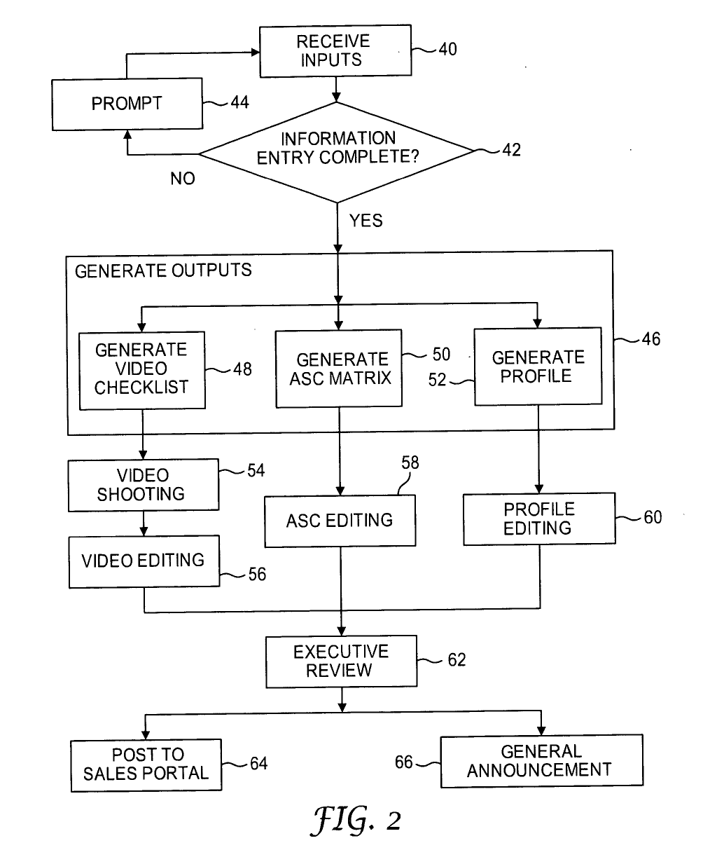

FIG. 2 is a flowchart illustrating generation of outputs 16, 18 and 20 based upon application inputs. Application package system 12 receives application inputs (40) from any of a number of users in any of a number of departments. Receiving inputs can be an iterative process involving contributions from different departments over time. When a user wishes to generate outputs 16, 18 and 20, and enters a command to do so, rules engine 34 of application package system 12 determines whether information entry is complete (42). In other words, rules engine 34 determines whether each linked account selection aspect, video production aspect and application profile aspect has been provided for the particular sales opportunity being evaluated. If any application inputs are missing or incomplete, rules engine 34 may prompt a user to supply missing data (44). Rules engine 34 authorizes generation of outputs 16, 18 and 20 when information entry is complete.

In the context of a spreadsheet, the computer executing the spreadsheet software receives application inputs (40) in cells, which are linked to one another as described above. When the software receives a command to generate outputs 16, 18 and 20, rules engine 34 determines whether information entry is complete (42) by checking the linked cells. When rules engine 34 determines that there is an application input in one of the cells but that application inputs in one or linked cells is missing, rules engine 34 may prompt a user to enter data into the vacant cells (44). When, for example, rules engine 34 finds a cell with a video production aspect, but also finds one or more cells linked to that cell are vacant, rules engine 34 may prompt a user to enter an account selection aspect or an application profile aspect pertaining to the subject matter of the video production aspect.

When information entry is complete, rules engine 34 permits application package system 12 to generate outputs (46). In this example, application package system 12 generates a video checklist 18, an account selection criteria (ASC) matrix 16 and an application profile 20 (48, 50 and 52).

The video checklist represents a set of directions to the video production department, so that a demonstrative and instructive video can be created that shows the features of the product and how it can be employed. The video checklist is a tool for the video production department for shooting footage (54) and for assembling and editing the footage into a finished video product (56). When generating video checklist 48, rules engine 34 ensures that any information designated for ASC matrix 16 or application profile 20 is associated with one or more video shots, and that the video checklist 48 clearly identifies those relationships.

The ASC matrix 16 serves as a blueprint for generation of an account selection criteria report for use in evaluating whether an application is appropriate for a particular customer. Typically, the account selection criteria matrix undergoes editing (58), which can include formatting, organizing and the like. Similarly, the application profile typically undergoes editing (60) before becoming final. Prior to generating the ASC matrix 16, rules engine 34 ensures that any information designated for inclusion within application profile 20 or to be highlighted by the video material is associated with selection criteria called out by the ASC matrix.

Similarly, prior to generating application profile 30 (52), rules engine 34 ensures that all selection criteria specified ASC matrix 16 and all information to be highlighted by the video material is associated with information described by the application profile.

Once produced, the final video, account selection criteria report and application profile can be subjected to executive review (62), in which a person or group evaluates the final video, account selection criteria report and application profile for accuracy and quality.

Once the final video, account selection criteria report and application profile are approved, they can be made available to others in the company, or as the company deems appropriate, to potential customers or the general public. The final versions can be posted electronically to a sales portal (64), for example, can be the subject of a general announcement (66) such as a product launch press release.

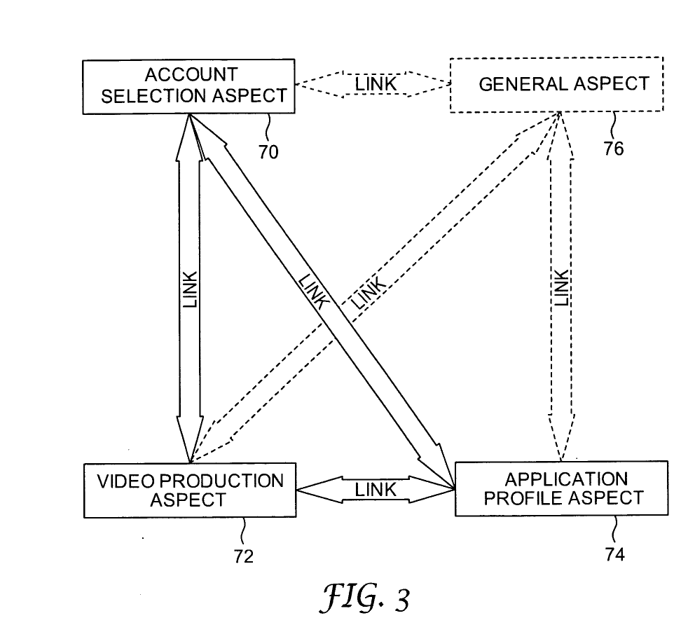

FIG. 3 is a conceptual diagram illustrating the linkages among application inputs that are automatically enforced by application package system 12 for each targeted sales application. As illustrated, an account selection aspect 70 is automatically linked to a video production aspect 72 and to an application profile aspect 74. The application inputs are linked to one another in the sense that the application inputs are related to each other and optionally required for evaluation and selection of an individual targeted sales application. The linked account selection aspect 70, video production aspect 72 and application profile aspect 74 form a triad of related information. When a user enters an application input of one type for a given sales application, the application input is automatically linked to slots (i.e., data storage areas such as rows within a relational database) for storing application inputs of the other two types of the triad.

In some circumstances, a user enters an application input for one aspect that is linked to a previously entered application input. For example, it may be the case that a first user wishing to enter a video production aspect pertaining to a specialized use of a product for a given targeted sales opportunity when a second user has previously entered an application profile aspect for this particular application. The first user, observing via user interface 32 that there is already an application profile aspect related to the same target application, can enter video production aspect in the slot linked to the application profile aspect.

In other circumstances, a user enters an application input for one aspect pertaining to a new, targeted sales application. In other words, the user enters an application input for an aspect for which there are no previously entered application inputs pertaining to that subject matter. For example, a first user wishing to enter a technical tip for an application profile may observe via user interface 32 that no one has yet entered any other application input pertaining to this subject matter. The user may therefore enter the application profile aspect, and doing so may cause application package system 12 to automatically generate slots pertaining to an account selection aspect and a video production aspect, and links these slots to the application profile aspect.

When a user wishes to generate the outputs for a particular application opportunity, rules engine 34 of application package system 12 determines whether each linked account selection aspect 70, video production aspect 72 and application profile aspect 74 includes at least one data entry. In some embodiments, such as an embodiment in which user interface 32 is a spreadsheet, rules engine 34 ignores empty triads, i.e., triads that have no application inputs in any of account selection aspect 70, video production aspect 72 and application profile aspect 74. If a triad has some application inputs but at least one component of the triad is missing an application input, rules engine 34 determines that data entry is not complete.

The invention does not require that each triad include a single account selection aspect 70, a single video production aspect 72 and a single application profile aspect 74. Rather, the invention supports triads that have multiple application inputs of each type.

As shown in FIG. 3, the invention may support the concept of a general aspect 76, which is an application input that is not confined to any particular type, but is linked to account selection aspect 70, video production aspect 72 and application profile aspect 74. In other words, additional aspects (i.e. dimensions or categories) for application input may be required. An example of general aspect 76 is product usage. Information about usage of a product may be useful to account selection, video production and application profile preparation. In some embodiments of the invention, general aspect 76 represents an optional data slot (i.e., data storage area). Rules engine 34 may for example, determine that data entry is complete even though there is no application input in an optional general aspect slot. In other embodiments, rules engine 34 may enforce a requirement that every general aspect have at least one account selection aspect, at least one video production aspect 72 and at least one application profile aspect 74 associated with it, before rules engine 34 determines that data entry is complete. In other words, rules engine 34 may require that each input of general aspect 76 be accompanied by inputs that recite how that general aspect would relate to account selection, video production and application profile preparation for a given application sales opportunity.

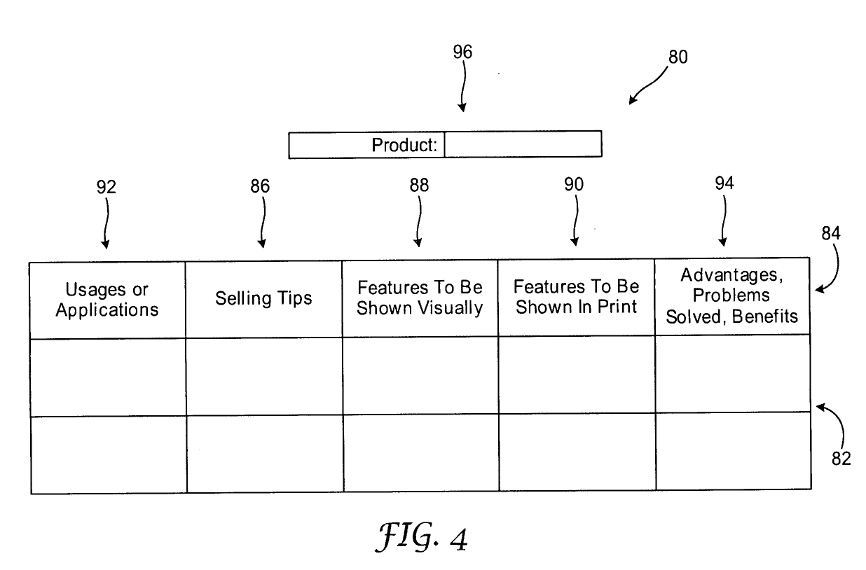

FIG. 4 is an exemplary display 80 presented by user interface 32 with which users interact to specify application inputs for a new sales application opportunity to be evaluated. In the example of FIG. 4, display can be embodied as a spreadsheet, comprising data entry cells 82 and titles for columns 84. As shown in FIG. 4, the columns need not be entitled “Account Selection Aspect,” “Video Production Aspect” and “Application Profile Aspect.” Rather, the columns can be given colloquial titles. Input entered under the column entitled “Selling Tips” 86 may be directed to an account selection aspect, because selling tips are principally directed to the targeting of a business that can employ a particular product. Input entered under the column entitled “Features to Be Shown Visually” 88 would typically be directed to a video production aspect, and input entered under the column entitled “Features to Be Shown In Print” 90 would typically be directed to an application profile aspect. Input entered under the columns entitled “Usages or Applications” 92, “Advantages, Problems Solved, Benefits” 94 and information about the product name or description could be deemed general aspects.

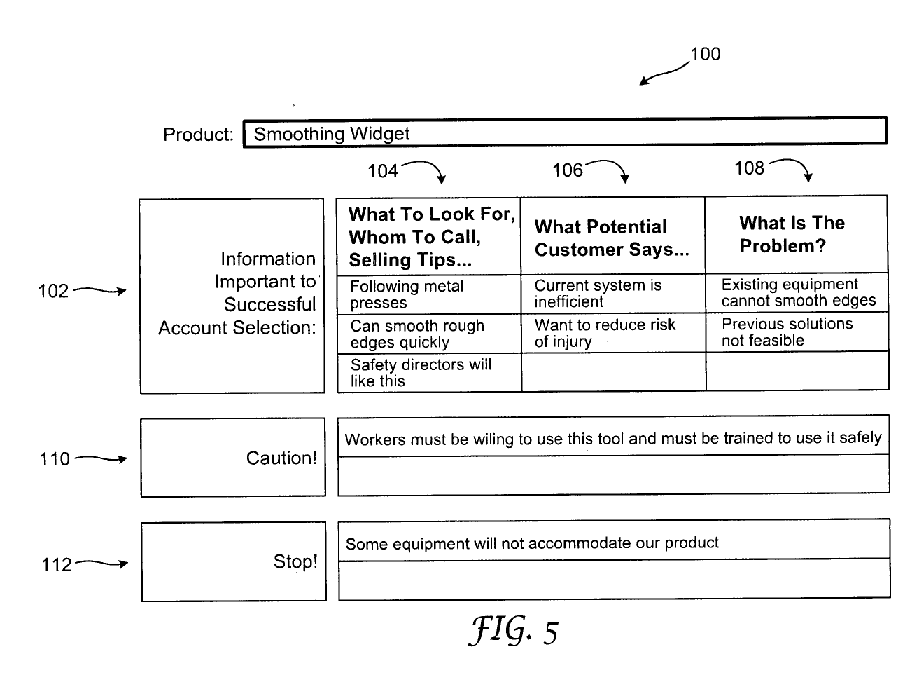

FIG. 5 is an example of an account selection criteria matrix 100 that could be output by application package system 12 to aid the determination of whether a customer is appropriate for the application sales opportunity. Examples of data may include information pertinent to account selection 102. Information pertinent to account selection 102 can be categorized according to selling angles 104, customer remarks 106 and problem descriptions 108. Further, account selection criteria matrix 100 may include cautionary information 110 that may militate against pursuing this business. Account selection criteria matrix 100 may also include considerations 112 that can rule out pursuing the business at all.

The invention is not limited to the information appearing in account selection criteria matrix 100 or the format of the data shown in FIG. 5. The information may include any application inputs that pertain to a potential new opportunity, customer needs, and how those needs could be met. As described above, rules engine 34 may require that each of the criteria of selection criteria matrix correlate to elements of the video material and the application profile for the application sales opportunity being evaluated and pursued.

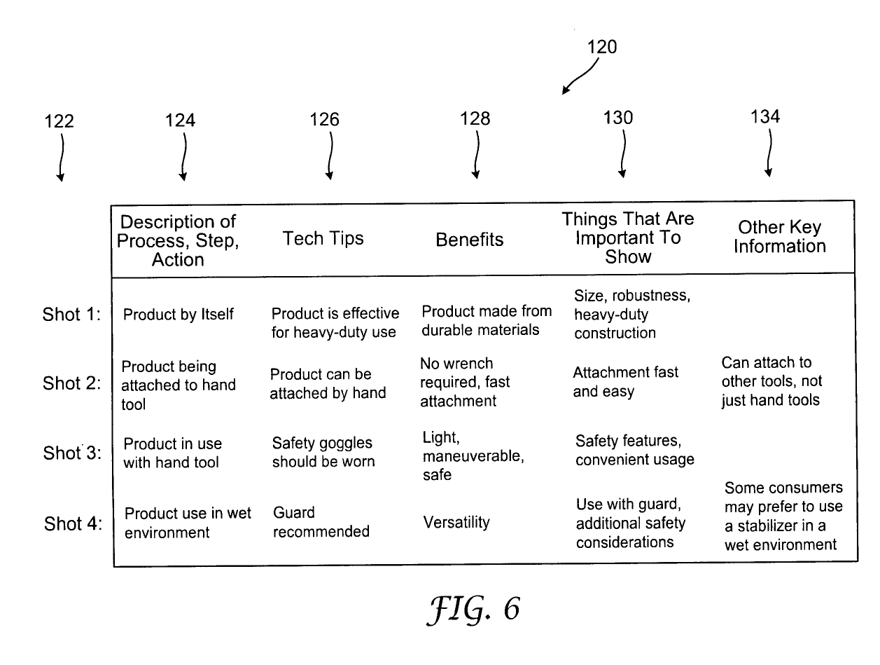

FIG. 6 is an example of a video checklist 120 produced by application package system 12 to drive the content of video material produced for a given targeted sales application. For each basic shot 122 of the video material, video checklist 120 specifies a list of the elements that should be presented in the video. Typical information useful for video production includes a basic description of what is being shown 124, technical tips pertaining to the subject matter of the shot 126, associated benefits 128 and an identification of features that are very important in the shot 130. Video checklist 120 can further include miscellaneous or other important information 134 that can be useful in the video. The invention is not limited to the information appearing in video checklist 120 or the format of the data shown in FIG. 6. As described above, rules engine 34 may require that each of the elements of video checklist 120 correlate to criteria of the selection criteria matrix and the application profile for the application sales opportunity being evaluated and pursued.

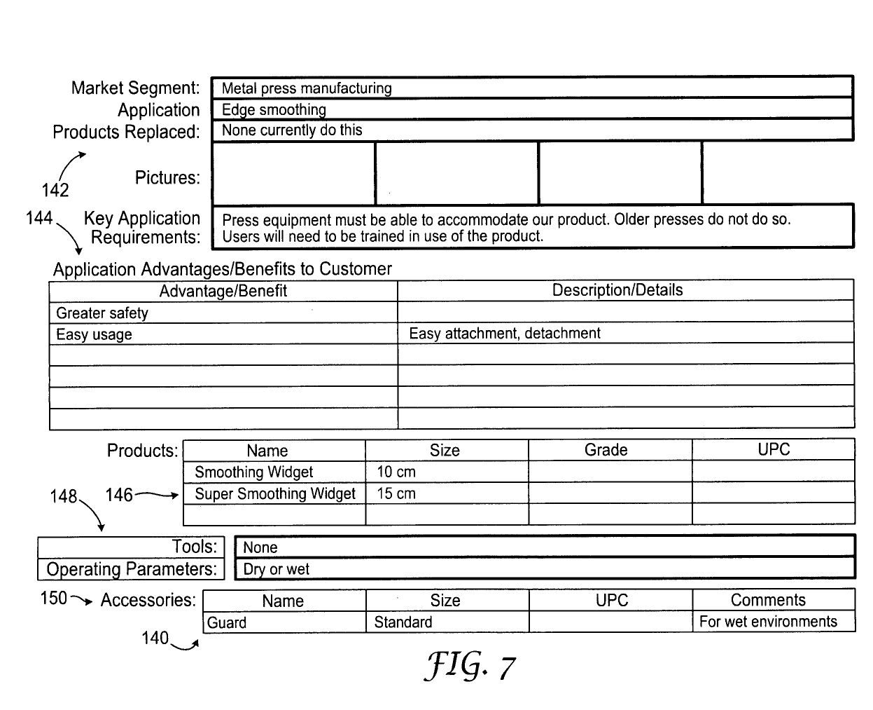

FIG. 7 is an example of an application profile 140. Application profile 140 displays application inputs pertaining to a market and the product's application in the market 142, advantages or benefits of the product in the market 144, technical specifications 146, tools and operating parameters for the product 148, accessories for the product 150, along with other pertinent information. The invention is not limited to the information appearing in application profile 140 or the format of the data shown in FIG. 7. As described above, rules engine 34 may require that each of the elements of application profile 140 correlate to criteria of the selection criteria matrix and elements of the video material for the application sales opportunity being evaluated and pursued.

The invention may bring about one or more advantages. By providing a centralized computing system for linking application inputs from many users for systematic evaluation of targeted application opportunities, the invention supports cooperation and teamwork among the users. Because there is typically subject matter overlap among account selection criteria, the invention empowers users to collect, aggregate and elaborate on information entered by other users. Users can further have access to the contributions of other users, and can more readily function as a team. Furthermore, the invention promotes the generation of an account selection criteria matrix, a video checklist and an application profile that consistently and harmoniously address application sales opportunity being evaluated and pursued.

Some of the techniques described above may be embodied as a computer-readable medium comprising instructions for a programmable processor in a computing system. The programmable processor may include one or more individual processors, which may act independently or in concert. A “computer-readable medium” includes but is not limited to read-only memory, Flash memory and a magnetic or optical storage medium.

Various embodiments of the invention have been described. These and other embodiments are within the scope of the following claims.

1. A computer-implemented system comprising:
a user interface configured to receive an account selection aspect, a video production aspect and an application profile aspect for a sales opportunity for an application of a product; and
a rules engine configured to permit output of an account selection criteria matrix, a video checklist, an application profile and approval of the sales opportunity when the user interface has received the account selection aspect, the video production aspect and the application profile aspect for the sales opportunity.

2. The system of claim 1, wherein the account selection aspect, the video production aspect and the application profile aspect are linked to one another.

3. The system of claim 1, wherein the rules engine is further configured to generate an output message when at least one of the account selection aspect, the video production aspect and the application profile aspect has not been entered.

4. The system of claim 1, further comprising a network-based sales portal configured to receive at least one of the account selection criteria matrix, the video checklist and the application profile and provide access by a plurality of users for evaluation of the sales opportunity.

5. The system of claim 1, wherein the user interface is configured to receive the account selection aspect, the video production aspect or the application profile aspect via a spreadsheet input environment.

6. A method comprising:
receiving an account selection aspect, a video production aspect and an application profile aspect that describe a sales opportunity for an application of a product or service of an enterprise; and
generating with a computer an account selection criteria matrix, a video checklist and an application profile after receiving the account selection aspect, the video production aspect and the application profile aspect.

7. The method of claim 6, wherein receiving the account selection aspect, the video production aspect and the application profile aspect comprises receiving the account selection aspect, the video production aspect and the application profile aspect in cells of a spreadsheet.

8. The method of claim 6, further comprising posting an electronic version of at least one of the account selection criteria matrix, the video checklist and the application profile to a sales portal.

9. The method of claim 6, further comprising receiving a command to generate the account selection criteria matrix, the video checklist and the application profile.

10. The method of claim 9, further comprising generating a warning after receiving the command, when at least one of the account selection aspect, the video production aspect and the application profile aspect is missing.

11. A method comprising:
receiving in a first input area of a software application operating on a computer a first application input for a sales opportunity, wherein the first application input comprises one application input type selected from an account selection aspect, a video production aspect and an application profile aspect, wherein the first input area is linked to a second input area for a second application input of a type different from the first application input, and wherein the first input area is linked to a third input area for a third application input of a type different from the first application input; and
controlling output of material for evaluation of the sales opportunity based on whether application inputs are provided for the linked first, second and third input areas.

12. The method of claim 11, further comprising:
receiving a command to generate an account selection criteria matrix, a video checklist and an application profile; and
generating with a computer an account selection criteria matrix, a video checklist and an application profile when the first input area is occupied by the first application input, the second input area is occupied by the second application input and the third input area is occupied by the third application input.

13. The method of claim 11, further comprising:
receiving a command to generate an account selection criteria matrix, a video checklist and an application profile; and
generating with a computer a warning when any of the first input area, the second input area or the third input area is vacant.

14. A computer-readable medium comprising instructions for causing a programmable processor to:
receive an account selection aspect, a video production aspect and an application profile aspect that describe a sales opportunity for an application of a product or service of an enterprise; and
generate with a computer an account selection criteria matrix, a video checklist and an application profile after receiving the account selection aspect, the video production aspect and the application profile aspect.

15. The medium of claim 14, wherein receiving the account selection aspect, the video production aspect and the application profile aspect comprises receiving the account selection aspect, the video production aspect and the application profile aspect in cells of a spreadsheet.

16. The medium of claim 14, wherein:
the instructions for causing the programmable processor to receive the account selection aspect comprise instructions for causing the programmable processor to receive the account selection aspect in a first input area of a software application,
the instructions for causing the programmable processor to receive the video production aspect comprise instructions for causing the programmable processor to receive the video production aspect in a second input area of the software application,
the instructions for causing the programmable processor to receive the application profile aspect comprise instructions for causing the programmable processor to receive the application profile aspect in a third input area of the software application,
the instructions further causing the programmable processor to link the first input area to the second input area and the third input area.

17. The medium of claim 14, the instructions further causing the programmable processor to receive a command to generate the account selection criteria matrix, the video checklist and the application profile.

18. The medium of claim 17, the instructions further causing the programmable processor to generate a warning after receiving the command, when at least one of the account selection aspect, the video production aspect and the application profile aspect is missing.
